(19) United States
(12) Patent Application Publication
(10) Pub. No.: US 2016/0141924 A1
(43) Pub. Date: May 19, 2016

(54) ROTOR OF WOUND ROTOR SYNCHRONOUS MOTOR

(71) Applicant: Hyundai Motor Company, Seoul (KR)

(72) Inventors: Sangjin Park, Hwaseong (KR); Yeonho Kim, Suwon (KR); Ki Nam Kim, Seongnam (KR)

(21) Appl. No.: 14/746,323

(22) Filed: Jun. 22, 2015

(30) Foreign Application Priority Data
Nov. 14, 2014 (KR) 10-2014-0158779

(51) Int. Cl. H02K 1/26

(52) U.S. Cl. CPC H02K 1/265

(57) ABSTRACT

A rotor of a wound rotor synchronous motor (WRSM) drive motor is arranged with a predetermined air gap to an inside surface of a stator, and the rotor may include a rotor core including steel sheets, where the rotor core may has rotor tees arranged at fixed intervals on an outside circumferential surface of a rotor body in a circumferential direction with a slot interposed between the rotor tees for winding a rotor coil thereon, and a rotor shoe formed at an end of each of the rotor tees opposite to the inside diametral surface of the stator, and the rotor core may have a plurality of core groups respectively having stacks of steel sheets with different shapes from one another, such that the rotor tees have different widths from one another in respective sections of a shaft in a shaft direction.

### CROSS-REFERENCE TO RELATED APPLICATION

This application claims under 35 U.S.C. §119(a) the benefit of Korean Patent Application No. 10-2014-0158779 filed in the Korean Intellectual Property Office on Nov. 14, 2014, the entire contents of which are incorporated herein by reference.

### BACKGROUND

(a) Technical Field

The present invention relates to a Wound Rotor Synchronous Motor (WRSM) drive motor, more particularly, to a rotor of the WRSM drive motor, in which a structure of a steel sheet stack of a rotor core is improved.

(b) Description of the Related Art

In general, a hybrid vehicle or an electric vehicle, each of which is referred to as an eco-friendly vehicle, may generate driving power with an electric motor (hereinafter called “drive motor”) which obtains torque from electrical energy.

As an example, the hybrid vehicle runs in an EV (Electric Vehicle) mode, which is a pure electric vehicle mode in which only power of the drive motor is used, or in an HEV (Hybrid Electric Vehicle) mode, which utilizes torque of the engine and the drive motor as the power sources. Generally, an electric vehicle runs by using torque of the drive motor as the power source.

Most of the drive motors which are used as power sources of the eco-friendly vehicles are Permanent Magnet Synchronous Motors (PMSM). In order to make the permanent magnet synchronous motor output the greatest performance in a limited layout condition, it is required to maximize performance of the permanent magnet.

In the permanent magnet, a neodymium (Nd) constituent improves strength of the permanent magnet, and a dysprosium (Dy) constituent improves high temperature demagnetization endurance. However, such rare earth metal (Nd and Dy) constituents of the permanent magnet are deposited in limited countries, such as China, are very expensive, and have big price fluctuations.

In order to avoid sourcing problems of permanent magnets, application of induction motors has been studied, but the application of induction motors has limitations due to an excessive increase of volume and weight for outputting the same motor performance.

In the meantime, recently, development of a Wound Rotor Synchronous Motor (WRSM) as a drive motor to be used for a power source of an eco-friendly vehicle has been undertaken for replacing the permanent magnet synchronous motor (PMSM).

The wound rotor synchronous motor has a coil that is wound, not only on a stator, but also on a rotor for electro-magnetizing the rotor when a current is applied to the rotor to replace the permanent magnet of the permanent magnet synchronous motor (PMSM).

The wound rotor synchronous motor has a rotor arranged inside of a stator with an air gap therebetween for forming a magnetic field upon application of power to the coils of the stator and the rotor, to rotate the rotor with a magnetic action occurring between the stator and the rotor.

Different from the permanent magnet synchronous motor, since the wound rotor synchronous motor has the rotor with the coil wound thereon, centrifugal force acting on the rotor coil at the time of high speed rotation (more than 10,000 rpm in the case of a typical EV) is extremely high.

Consequently, the wound rotor synchronous motor may have alignability of the rotor coil become poor at the time of the high speed rotation of the rotor, to cause a fault due to the centrifugal force acting on the rotor coil. Accordingly, winding of the rotor coil to have alignability is critically important for securing mechanical strength stability with respect to the centrifugal force of the rotor coil.

In the meantime, the rotor of the wound rotor synchronous motor has a rotor core made of a stack of steel sheets. The rotor core may have the rotor coil wound thereon with a plurality of poles in a shape to either be symmetrical in an axis direction, in a skewed shape, or in a stack of steel sheets of identical shapes.

In order to have the rotor core of a unitary type with the rotor coil wound thereon, rather than a split core type, the rotor coil is wound on all of the poles of the rotor core by using a nozzle type of winding machine.

In this case, if the stack of steel sheets of the rotor core has a length that is relatively smaller than an outside diameter of the motor, winding of the rotor coil is easy. However, if the length of the stack of steel sheets of the rotor core is increased for increasing torque of the motor, a length of the rotor coil winding in the axis direction also increases.

Therefore, if the rotor coil is wound while having a relatively long length (an axis direction length) of the steel sheet stack with the nozzle type of winding machine in the related art, tension of the rotor coil may become weak in an axis direction section to cause, as an example, sagging of the rotor coil, making the alignability of the rotor core poor.

The above information disclosed in this background section is only for enhancement of understanding of the background of the invention and therefore it may contain information that does not form the prior art that is already known to a person of ordinary skill in the art.

### SUMMARY

The present invention provides a rotor of a wound rotor synchronous motor (WRSM) drive motor having advantages of improving a steel sheet stack structure of a rotor core.

An object of the present invention is to provide a rotor of a WRSM drive motor in which a long steel sheet stack structure of a rotor core is improved for securing alignability of the rotor coil.

To achieve the object of the present invention, the rotor of the WRSM drive motor arranged with a predetermined air gap to an inside surface of a stator is provided, and the rotor may include a rotor core of a stack of a plurality of steel sheets, wherein the rotor core may include a plurality of rotor tees arranged at fixed intervals on an outside circumferential surface of a rotor body in a circumferential direction with a slot interposed between the rotor tees for winding a rotor coil thereon, and a rotor shoe formed at an end of each of the rotor tees opposite to the inside surface of the stator, and the rotor core may have a plurality of core groups respectively having stacks of steel sheets with different shapes from one another, such that the rotor tees may have different widths from one another in respective sections of a shaft in a shaft direction.

In the preferred embodiment of the present invention, the rotor core may have first core groups respectively formed on both ends in the shaft direction, and at least one second core group formed between the first core groups.

In the preferred embodiment of the present invention, the first and second core groups may have rotor tees with different widths from each other.

In the preferred embodiment of the present invention, the width of each of the rotor tees of the second core group may be relatively larger than the width of each of the rotor tees of the first core group.

In the preferred embodiment of the present invention, the first and second core groups may have the rotor shoes with different widths from each other.

In the preferred embodiment of the present invention, the first and second core groups have the rotor shoes with different eccentric arcs from each other.

In the preferred embodiment of the present invention, the first and second core groups have the rotor shoes with air gap radii to the inside surface of the stator that are different from each other. In a preferred embodiment of the present invention, the first and second core groups form a corner step therebetween corresponding to a difference of the widths of the rotor tees.

In the preferred embodiment of the present invention, the rotor core may have first core groups on both ends in the shaft direction, second core groups between the first core groups adjacent to respective first core groups, and at least one third core group between the second core groups.

In the preferred embodiment of the present invention, the first, second, and third core groups may be stacks of steel sheets with different shapes from one another.

In another preferred embodiment of the present invention, a rotor of a WRSM drive motor arranged with a predetermined air gap to an inside surface of a stator, the rotor may include a rotor core of a stack of a plurality of steel sheets, wherein the rotor core may include a plurality of rotor tees arranged at fixed intervals on an outside circumferential surface of a rotor body in a circumferential direction with a slot interposed between the rotor tees for winding a rotor coil thereon, and a rotor shoe formed at an end of each of the rotor tees opposite to the inside surface of the stator, and the rotor core may have a plurality of core groups respectively having stacks of steel sheets with shapes different from one another, such that the rotor shoes may have different widths from one another in respective sections of a shaft in a shaft direction.

In a further preferred embodiment of the present invention, a rotor of a WRSM drive motor arranged with a predetermined air gap to an inside surface of a stator is provided, and the rotor may include a rotor core of a stack of a plurality of steel sheets, wherein the rotor core may include a plurality of rotor tees arranged at fixed intervals on an outside circumferential surface of a rotor body in a circumferential direction with a slot interposed between the rotor tees for winding a rotor coil thereon, and a rotor shoe formed at an end of each of the rotor tees opposite to the inside surface of the stator, and the rotor core may have a plurality of core groups respectively having stacks of steel sheets with different shapes from one another, such that the rotor shoes may have different eccentric arcs from one another in respective sections of a shaft in a shaft direction.

The rotor of a WRSM drive motor in accordance with the preferred embodiment of the present invention may hold a wound coil while reducing a straight portion distance of the coil in the shaft direction owing to the corner step of the second core group when the rotor coil is wound on the rotor core by the nozzle winding method.

Accordingly, in the preferred embodiment of the present invention, alignability of the rotor coil may be secured by improving the tension of the rotor coil with the corner step of the second core group at the time of carrying out the nozzle winding, improving workability and mass productivity at the time of carrying out the nozzle winding, increasing a conductor-occupying ratio, and improving performance and efficiency of the motor.

In the preferred embodiment of the present invention, the formation of the widths of the first and second rotor shoes of the first and second core groups that are different from each other permits adjustment of an air gap length between an inside surface of the stator and the first and second rotor shoes.

Therefore, the preferred embodiment of the present invention may reduce torque ripple while minimizing a change rate of magnetic resistance varying with a relative position of the stator and the rotor, and may improve motor torque and noise/vibration design freedoms.

Moreover, in the preferred embodiment of the present invention, since a length of a coil end portion of the rotor coil which has no contribution to generation of the torque through the corner step of the second core group may be reduced, reduction of copper use occurring at the rotor coil is possible, further enabling improvements in the performance and efficiency of the motor.

### BRIEF DESCRIPTION OF THE DRAWINGS

The attached drawings illustrate preferred embodiments of the present invention, and are provided for describing the present invention in more detail but not for limiting technical aspects of the present invention.

FIG. 1 illustrates a schematic view of a rotor of a wound rotor synchronous motor (WRSM) drive motor in accordance with a preferred embodiment of the present invention.

FIGS. 2 (a) and (b) illustrate schematic views of a portion of a rotor core applicable to the rotor of the WRSM drive motor of FIG. 1.

FIG. 3 illustrates a schematic view of a winding state of a rotor coil in a stacking structure of a rotor core applicable to the rotor of the WRSM drive motor of FIG. 1.

FIG. 4 illustrates a schematic view of a rotor of a WRSM drive motor in accordance with another preferred embodiment of the present invention.

FIGS. 5 (a) and (b) illustrate schematic views of a portion of a rotor core applicable to the rotor of the WRSM drive motor of FIG. 4.

FIG. 6 illustrates a schematic view of a rotor of a WRSM drive motor in accordance with a further preferred embodiment of the present invention.

### DETAILED DESCRIPTION OF THE EMBODIMENTS

The present invention will be described more fully hereinafter with reference to the accompanying drawings, such that persons in this field of art can carry out easily. However, the present invention may be embodied in different modes, and is not limited to the description of embodiments made herein.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Parts not relevant to the present invention will be omitted for describing the present invention clearly, and throughout the specification, identical or similar parts will be given the same reference numbers.

Since sizes and thicknesses of elements are shown at will for convenience of description, the present invention is not limited to the drawings without fail, but the thicknesses are enlarged for clearly expressing different parts and regions.

Further, although terms including ordinal numbers, such as first or second, can be used for describing various elements, the elements are not confined by the terms, and are used only for making one element distinctive from other elements.

Further, terms such as “. . . unit”, “. . . means”, “. . . portion”, “. . . member”, and so on in the specification mean units of a general element having at least one function or operation.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Further, the control logic of the present invention may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

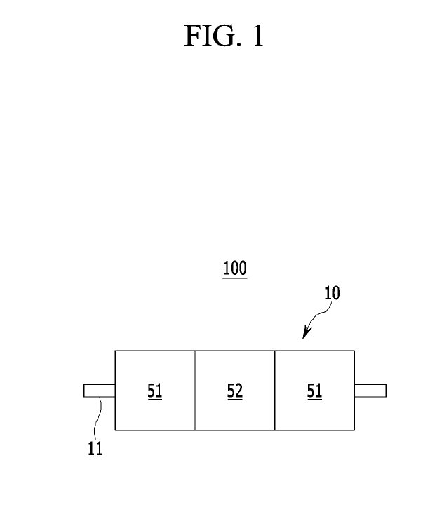

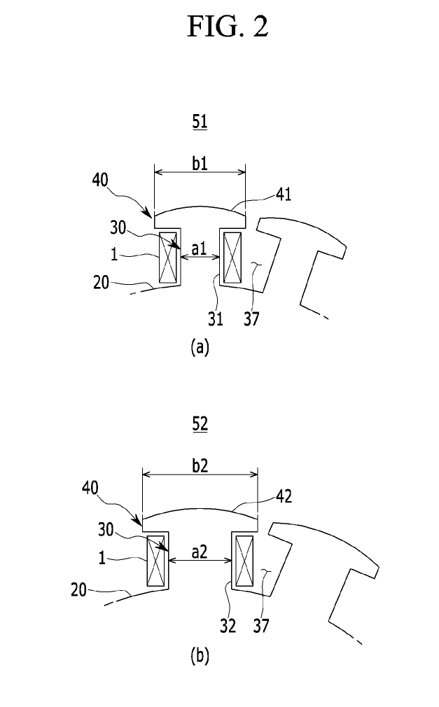

FIG. 1 illustrates a schematic view of a rotor of a wound rotor synchronous motor (WRSM) drive motor in accordance with a preferred embodiment of the present invention, and FIGS. 2 (a) and (b) illustrate schematic views of a portion of a rotor core applicable to the rotor of the WRSM drive motor.

Referring to FIGS. 1 and 2(a)-2(b), the WRSM drive motor in accordance with a preferred embodiment of the present invention may be applied to a drive motor in a hybrid vehicle which obtains drive power through electrical energy in an eco-friendly vehicle.

As an example, the wound rotor synchronous motor includes a stator (not shown) having a stator coil (not shown) wound thereon, and a rotor 100 in accordance with a preferred embodiment of the present invention arranged inside of the stator having a rotor coil 1 (see FIGS. 2(a)-(b) hereafter) wound thereon.

The rotor 100 has a rotation shaft (not shown) coupled to a center portion thereof and arranged to the inside of the stator with a predetermined air gap between an outside surface of the rotor 100 and an inside surface of the stator.

Accordingly, the wound rotor synchronous motor may have the rotor coil 1 wound, not only on the stator, but also on the rotor 100 for electro-magnetizing the rotor 100 when a current is applied thereto to generate a drive torque by attractive force and repulsive force between the electromagnet of the rotor 100 and the electromagnet of the stator.

Moreover, the rotor 100 in accordance with the preferred embodiment of the present invention may include a plurality of rotor tees 30 arranged at fixed intervals in a circumferential direction of an outside circumferential surface of a rotor body 20 having the rotation shaft 11 coupled thereto as a rotor core 10 of a stack of a plurality of electrical sheets.

The rotor tees 30, for winding the rotor coil 1 thereon, have a slot 37 formed between the rotor tees 30 for winding the rotor coil 1. In particular, the rotor tees 30 may be arranged on the rotor body 20 at fixed intervals in a circumferential direction thereof with the slot 37 interposed therebetween.

In this case, the slot 37 between the rotor tees 30 may have an insulating resin (not shown) molded therein for insulating the rotor coil 1 wound on the rotor tees 30. Further, the rotor tees 30 have a rotor shoe 40 formed at ends thereof opposite to an inside surface of the stator with a predetermined air gap therebetween for holding the rotor coil 1.

The rotor 100 of a wound rotor synchronous motor (WRSM) drive motor in accordance with the preferred embodiment of the present invention having a structure which has an increased shaft direction staking length of the steel sheets for increasing the torque has a structure in which a steel sheet stacking structure of the rotor core 10 is improved for securing alignability of the rotor coil.

In particular, the preferred embodiment of the present invention provides a rotor 100 of a wound rotor synchronous motor (WRSM) drive motor which may secure alignability of the rotor coil 1 with respect to the rotor core 10 for improving torque and efficiency of the motor, noise and vibration characteristics, and workability and mass productivity at the time of carrying out nozzle winding.

The rotor 100 of the wound rotor synchronous motor (WRSM) drive motor in accordance with the preferred embodiment of the present invention may have the rotor core 10 which may form a plurality of core groups 51 and 52 having steel sheets with different shapes from one another, such that widths of the rotor tees 30 are different from one another in respective predetermined sections of the rotor 100 in the shaft direction.

For example, in the preferred embodiment of the present invention, first core groups 51 may be formed on both ends of the rotor core 10 in the shaft direction, respectively, and a second core group 52 may be formed between the first core groups 51. In this case, the first and second core groups 51 and 52 may be respectively mounted to the rotation shaft (not shown) after the plurality of steel sheets are stacked.

Hereafter, the rotor tees at the first core group 51 will be defined as first rotor tees 31, and the rotor tees at the second core group 52 will be defined as second rotor tees 32. Further, the rotor shoe at the first core group 51 will be defined as a first rotor shoe 41, and the rotor shoe at the second core group 52 will be defined as a second rotor shoe 42.

The first and second core groups 51 and 52 in the preferred embodiment of the present invention have widths a1 and a2 of the first and second rotor tees 31 and 32 that are different from each other. For example, as shown in FIGS. 2(a)-2(b), the second rotor tees 32 of the second core group 52 may have a width a2 that is larger than a width a1 of the first rotor tees 31 of the first core group 51.

Moreover, as shown in FIGS. 2(a)-2(b), the first and second core groups 51 and 52 may have widths b1 and b2 of the first and second rotor shoes 41 and 42 that are different from each other.

Alternatively, the present invention is not limited to the first and second rotor shoes 41 and 42 having widths b1 and b2 that are different from each other, and the widths b1 and b2 of the first and second rotor shoes 41 and 42 may be same.

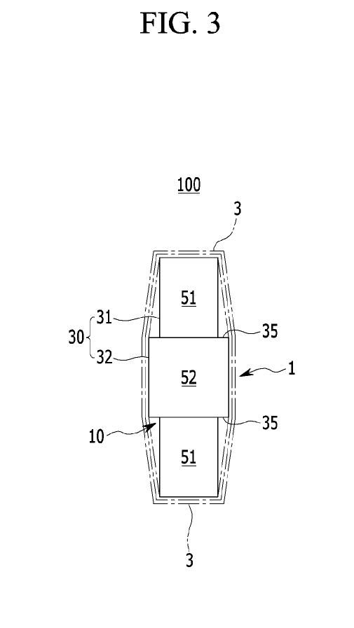

In the preferred embodiment of the present invention, as the second rotor tees 32 of the second core group 52 have the larger width a2 than the width a1 of the first rotor tees 31 of the first core group 51, a shape of the rotor core 10 shown in FIG. 3 may be formed.

In further detail, in the preferred embodiment of the present invention, a corner step 35 corresponding to a difference of the widths of the first and second rotor tees 31 and 32 is formed between the first and second core groups 51 and 52.

In particular, in the preferred embodiment of the present invention, as the first core groups 51 are respectively positioned on both ends of the rotation shaft 11 and the second core group 52 is positioned between the first core groups 51, and the second rotor tees 32 of the second core group 52 have the larger width a2 than the width a1 of the first rotor tees of the first core group 51, the corner step 35 may be formed at the second core group 52.

In other words, in the preferred embodiment of the present invention, as the second core group 52 having the second rotor tees 32 with the larger width than the width of the first rotor tees 31 of the first core groups 51 is positioned at the middle of the shaft in the shaft direction and the first core groups 51 are positioned on respective sides of the shaft in the shaft direction, the corner step 35 may be formed at the second core group 52.

Eventually, the rotor 100 of a wound rotor synchronous motor (WRSM) drive motor in accordance with the preferred embodiment of the present invention may hold a wound coil while reducing a straight portion distance of the coil in the shaft direction owing to the corner step 35 of the second core group 52 when the rotor coil 1 is wound on the rotor core 10 by the nozzle winding method.

Thus, in the preferred embodiment of the present invention, alignability of the rotor coil 1 may be secured by improving the tension of the rotor coil 1 with the corner step 35 of the second core group 52 at the time of carrying out the nozzle winding, enabling workability and mass productivity improvement at the time of carrying out the nozzle winding, in order to increase a conductor-occupying ratio, and to improve performance and efficiency of the motor.

Moreover, in the preferred embodiment of the present invention, the formation of the widths b1 and b2 of the first and second rotor shoes 41 and 42 of the first and second core groups 51 and 52 that are different from each other permits adjustment of an air gap between an inside surface of the stator and the first and second rotor shoes 41 and 42.

The preferred embodiment of the present invention may reduce torque ripple while minimizing a change rate of magnetic resistance that varies with a relative position of the stator and the rotor, and may improve motor torque and noise/vibration design freedoms.

Moreover, in the preferred embodiment of the present invention, since a length of a coil end portion 3 (see FIG. 3) of the rotor coil 1 which has no contribution to generation of the torque through the corner step 35 of the second core group 52 may be reduced, reduction of copper use in the rotor coil 1 is possible, enabling the performance and efficiency of the motor to be further improved.

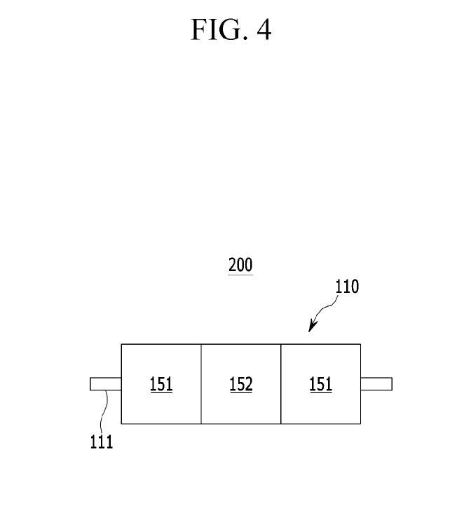

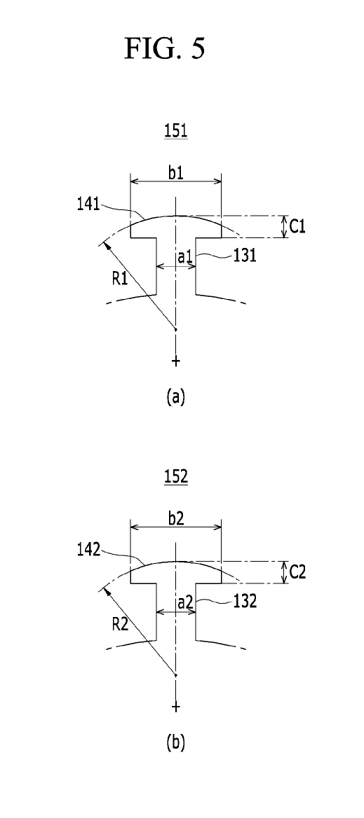

FIG. 4 illustrates a schematic view of a rotor of a wound rotor synchronous motor (WRSM) drive motor in accordance with another preferred embodiment of the present invention, and FIGS. 5 (a) and (b) illustrate schematic views of a portion of a rotor core applicable to the rotor of the WRSM drive motor of FIG. 4.

Referring to FIGS. 4 and 5(a)-5(b), like the foregoing preferred embodiment of the present invention, while having first and second rotor tees 131 and 132 with widths a1 and a2 that are different from each other as a basis, a rotor 200 of a wound rotor synchronous motor (WRSM) drive motor in accordance with another preferred embodiment of the present invention may have a rotor core 110 including first and second core groups 151 and 152 having first and second rotor shoes 141 and 142 with eccentric arcs c1 and c2 that are different from each other.

In the preferred embodiment of the present invention, the first and second rotor shoes 141 and 142 of the first and second core groups 151 and 152 may have air gap radii R1 and R2 to an inside surface of the stator that are different from each other.

In this case, the widths b1 and b2 of the first and second rotor shoes 141 and 142 may or may not be the same.

Therefore, in the preferred embodiment of the present invention, since eccentric arcs c1 and c2 of the first and second rotor shoes 141 and 142 of the first and second core groups 151 and 152 are different from each other, and the air gap radii R1 and R2 of the first and second rotor shoes 141 and 142 of the first and second core groups 151 and 152 to the inside surface of the stator are different from each other, the design freedom of the motor torque and the noise/vibration may be improved.

In the meantime, although the current preferred embodiment of the present invention is described such that, as a base of a structure of the rotor core 110, the widths a1 and a2 of the first and second rotor tees 131 and 132 are different from each other, and the rotor core 110 includes the first and second core groups 151 and 152 having the first and second rotor shoes 141 and 142 with widths b1 and b2 and/or the eccentric arcs c1 and c2 that are different from each other, the present invention is not limited thereto.

Alternatively, in the present invention, while as a basis of the structure of the rotor core 110, the widths a1 and a2 of the first and second rotor tees 131 and 132 are the same as each other, the rotor core 110 may include the first and second core groups 151 and 152 having the first and second rotor shoes 141 and 142 with the widths b1 and b2 that are different from each other.

In particular, in the present invention, the rotor core 110 may include a plurality of core groups 151 and 152 having stacks of steel sheets of shapes that are different from each other, such that the rotor shoes 141 and 142 have the widths b1 and b2 that are different from each other in respective predetermined sections of the shaft in a shaft direction.

Moreover, in the present invention, while as a basis of the structure of the rotor core 110, the widths a1 and a2 of the first and second rotor tees 131 and 132 are the same as each other, the rotor core 110 may include the first and second core groups 151 and 152 having the first and second rotor shoes 141 and 142 with the eccentric arcs c1 and c2 that are different from each other.

In particular, in the present invention, the rotor core 110 may include the first and second core groups 151 and 152 having stacks of steel sheets with shapes that are different from each other, such that the rotor shoes 141 and 142 have the eccentric arcs c1 and c2 that are different from each other in respective predetermined sections of the shaft in the shaft direction.

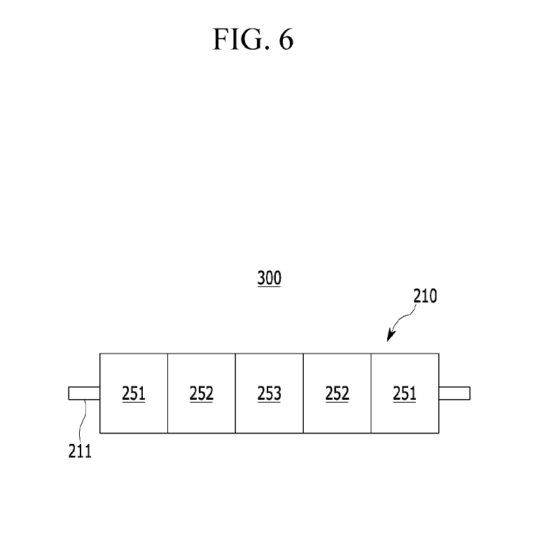

FIG. 6 illustrates a schematic view of a rotor of a wound rotor synchronous motor (WRSM) drive motor in accordance with a further preferred embodiment of the present invention.

Referring to FIG. 6, like the foregoing embodiments, a rotor 300 of the WRSM drive motor may include a rotor core 210 having two or more core groups 251 and 252 with shapes of steel sheet stacks that are different from each other.

For example, in the further preferred embodiment of the present invention, first core groups 251 may be formed on both ends of a rotation shaft 211 in a shaft direction, respectively, second core groups 252 may be formed therebetween and adjacent thereto, and at least one third core group 253 may be formed between the second core groups 252.

Since other configurations and effects of the rotor 300 of a wound rotor synchronous motor (WRSM) drive motor in accordance with the current preferred embodiment of the present invention are identical to the foregoing embodiments, detailed description thereof will be omitted.

While this invention has been described in connection with what is presently considered to be practical exemplary embodiments, it is to be understood that technical aspects of the present invention are not limited to the exemplary embodiments suggested in the specification, but, although a person of ordinary skill in this field of art who understands the technical aspects of the present invention can suggest other exemplary embodiments by modifications, changes, removal, and/or addtion of constituent elements within a range of technical aspects as in the present invention, they may also be within a range of right of the present invention.

What is claimed is:

1. A rotor of a wound rotor synchronous motor (WRSM) drive motor arranged with a predetermined air gap to an inside surface of a stator, the rotor comprising:
a rotor core including a plurality of steel sheets,
wherein the rotor core includes a plurality of rotor tees arranged at fixed intervals on an outside circumferential surface of a rotor body in a circumferential direction with a slot interposed between the rotor tees for winding a rotor coil thereon, and a rotor shoe formed at an end of each of the rotor tees opposite to the inside surface of the stator, and
the rotor core has a plurality of core groups respectively having stacks of steel sheets with different shapes from one another, such that the rotor tees have different widths from one another in respective sections of a shaft in a shaft direction.

2. The rotor of claim 1, wherein the rotor core has first core groups respectively formed on both ends in the shaft direction, and at least one second core group formed between the first core groups, and the first and second core groups have rotor tees with widths different from each other.

3. The rotor of claim 2, wherein the width of each of the rotor tees of the second core group is relatively larger than the width of each of the rotor tees of the first core group.

4. The rotor of claim 3, wherein the first and second core groups have the rotor shoes with different widths from each other.

5. The rotor of claim 3, wherein the first and second core groups have the rotor shoes with different eccentric arcs from each other.

6. The rotor of claim 3, wherein the first and second core groups have the rotor shoes with air gap radii to the inside surface of the stator that are different from each other.

7. The rotor of claim 2, wherein the first and second core groups form a corner step therebetween corresponding to a difference of the widths of the rotor tees.

8. The rotor of claim 1, wherein the rotor core has first core groups on both ends in the shaft direction, second core groups between the first core groups adjacent to respective first core groups, and at least one third core group between the second core groups, wherein the first, second, and third core groups are stacks of steel sheets with different shapes from one another.

9. A rotor of a wound rotor synchronous motor (WRSM) drive motor arranged with a predetermined air gap to an inside surface of a stator, the rotor comprising
a rotor core including a plurality of steel sheets,
wherein the rotor core includes a plurality of rotor tees arranged at fixed intervals on an outside circumferential surface of a rotor body in a circumferential direction with a slot interposed between the rotor tees for winding a rotor coil thereon, and a rotor shoe formed at an end of each of the rotor tees opposite to the inside surface of the stator, and
the rotor core has a plurality of core groups respectively having stacks of steel sheets with different shapes from one another, such that the rotor shoes have different widths from one another in respective sections of a shaft in a shaft direction.

10. A rotor of a wound rotor synchronous motor (WRSM) drive motor arranged with a predetermined air gap to an inside diametral surface of a stator, the rotor comprising
a rotor core including a plurality of steel sheets,
wherein the rotor core includes a plurality of rotor tees arranged at fixed intervals on an outside circumferential surface of a rotor body in a circumferential direction with a slot interposed between the rotor tees for winding a rotor coil thereon, and a rotor shoe formed at an end of each of the rotor tees opposite to the inside surface of the stator, and
the rotor core has a plurality of core groups respectively having stacks of steel sheets with different shapes from one another, such that the rotor shoes have different eccentric arcs from one another in respective sections of a shaft in a shaft direction.
